(19) United States
(12) Patent Application Publication
(10) Pub. No.: US 2018/0126694 A1
(43) Pub. Date: May 10, 2018

(54) METHOD FOR PREPARING CHEMICAL CROSS LINKED POLYETHYLENE CLOSED CELL FOAM WITH AIR GAPS DESIGNED TO ACHIEVE DESIRED EFFICACY

(71) Applicant: THE SUPREME INDUSTRIES LIMITED, Mumbai, Maharashtra (IN)

(72) Inventors: Ghosh Amit Kumar, Aundh (IN); Jha Gourishankar, Aundh (IN); Guleria Ajay Kumar, Aundh (IN); Singh Vijay Kumar, Aundh (IN)

(21) Appl. No.: 15/573,767

(22) PCT Filed: Apr. 7, 2016
(86) PCT No.: PCT/IN2016/000087

§ 371 Date: Nov. 13, 2017

(30) Foreign Application Priority Data
Aug. 12, 2015 (IN) 3047/MUM/2015

(51) Int. Cl. B32B 5/18; B32B 5/32; B32B 3/30; B32B 27/06; B32B 27/08; B32B 27/32; B32B 15/04; B32B 15/085; B32B 15/20; B29C 44/24; B29C 44/34; C08L 23/06

(52) U.S. Cl. CPC B32B 5/18; C08L 2207/066; B32B 3/30; B32B 27/065; B32B 27/08; B32B 27/32; B32B 15/046; B32B 15/085; B32B 15/20; B29C 44/24; B29C 44/355; C08L 23/06; B32B 2266/025; B32B 2266/08; B32B 2307/102; B32B 2307/304; B32B 2307/546; B32B 2307/732; B32B 5/32

(57) ABSTRACT

The present invention discloses a closed cell foam made of cross linked polyethylene and also discloses a method to produce the foam. The foam has an enhanced property of providing better thermal insulation and the same is achieved by incorporation of air gaps in the polyethylene foam.

### FIELD OF INVENTION

The invention relates to a method of preparing a cross linked polyethylene closed cell foam with a particular design to achieve desired efficacy of thermal insulation by increasing air gaps between the sheets of cross linked low density polyethylene. The present invention also provides a method for manufacturing the customized design cross-linked polyethylene foam.

### BACKGROUND

Polyethylene foams and cross-linked polyethylene foams possess a characteristic ability to withstand great amount of pressure without losing its original cushioning properties and sustained durability and are used in various thermal insulation materials.

Presently, copper piping and a tubular thermal insulation material cladded on the copper pipe has been widely used for heat insulation purposes. Apart from the copper pipe, low density PE, low-density linear PE formed by copolymerizing ethylene with a 4-8C alpha-olefin have been used as heat insulating material for roofing materials or external wall materials of a house.

A duct lining insulation system is also known for lining variable air volume boxes, air handling units and ducts for heat ventilation and air conditioning. It has a sheet of a flexible, closed cell foam composition and the said sheet has a face with a substantially smooth surface comprising of a coating of a pressure sensitive adhesive.

However, these above mentioned thermal insulating materials have a complicated construction of layers, making these cross linked PE foams expensive and often devoid of better insulation.

Apart from this the material used in does not have air gaps in them. The thermal conductivity of the plain XLPE foam material used in them is of 0.034 W/m·K. The material is cross-linked LDPE foam sheets laminated to each other to build up the desired thickness. The lesser the thermal conductivity value better is the thermal insulation.

In conventional design of cross linked polyethylene foam, substantial amount of polymer is used, though the desired efficacy of both thermal and sound insulation is yet to be achieved, as these methods are complicated and costly as well.

In view of the aforementioned problems and issues existing in the industry it is highly desirable to provide for a different kind of cross linked polyethylene foam which involves use of material and a system which is more economical less expensive and more effective which ensures low value thermal conductivity and a better thermal insulation.

The present invention is an attempt to provide for a method for preparing cross-linked polyethylene foam with less quantity of polymer, low value thermal conductivity and higher thermal insulation. There is an increased efficacy of insulation achieved in the foam by increasing the air gaps between sheets of cross-linked low-density polyethylene. This is achieved with the air gaps as it is a proven fact technically air is a very good insulator for thermal conductivity and thereby ensuring a better increased sound insulation.

U.S. Pat. No. 6,007,890 discloses a multilayered insulating panel having improved acoustic insulating properties by having two outer facings and a soft synthetic foam core having cavities between in a manner that the cavities are arranged so that the gaps between the core material and the outer facings are in alternate patterns. However, the present invention discloses a method of preparation of cross-linked polyethylene foam that has uniformed air gaps in the form of ribs or tunnels. Moreover, the disclosed cross-linked polyethylene foam possesses thermal insulation properties having a lower thermal conductivity of around 0.026 W/m·K±0.05 W/m·K. Also, the cross-linked polyethylene foam along with thermal conductivity also possesses acoustic insulation properties.

### OBJECT OF THE INVENTION

It the object of the present invention to provide for a design of cross linked polyethylene closed cell foam which will require less amount of expensive polymer and increase efficacy of insulation by providing the air gaps between the sheets of cross linked close cell LDPE foam.

It is yet another object of invention to provide for a cross-linked polyethylene close cell foam with increase thermal and sound insulation.

It is yet further object of the invention to provide for a method of manufacturing cross-linked polyethylene with corrugation or ribs or tunnels or air gaps. It is yet another object of the invention to provide for a method and a design of a cross-linked polyethylene with economically less expensive polymer along with a well designed air gap system to achieve higher efficacy of insulation.

### SUMMARY OF THE INVENTION

The present invention is related to cross linked polyethylene close cell foam which provides better thermal and sound insulation, better flexibility, and in a cost effective manner by incorporating air gaps.

The present invention provides for a new economical in cost design in mold of cross-linked polyethylene foam which incorporates substantially less amount of expensive polymer without compromising the technical functionalities of the final product thereby reducing 20% of lesser use of the total polymer used for the final product. The desired efficacy of insulation is achieved by increasing air gaps between sheets of cross-linked closed cell LDPE (low density polyethylene) foam.

Air is a very good insulator, for instance the thermal conductivity of air is 0.024 W/m·K, which is much better than cross linked PE foams (the lower figure the better). In this product, we plan to combine the strength of air and cross-linked foam to come up with novel product with lower thermal conductivity and better sound insulation.

The foam comprises a fundamental unit having an aluminium foil top cover, and sheet of cross-linked LDPE and ribbed cross-linked LDPE. According to the invention, one or two layers of evenly spaced air gaps exist preferably in the ribbed ross-linked LDPE by the lamination of two or more layers, thereby reducing the material used and simultaneously improving thermal insulation conditions.

The present invention also provides a method for manufacturing the improved cross-linked polyethylene foam.

### BRIEF DESCRIPTION OF THE ACCOMPANYING DRAWINGS

The nature and scope of the present invention will be better understood from the accompanying drawings, which are by way of illustration of two preferred embodiments and not by way of any sort of limitation. In the accompanying drawings,

FIG. 1 illustrates a preferred embodiment of a fundamental unit of the cross-linked polyethylene foam according to the present invention.

FIG. 2 illustrates another preferred embodiment of a fundamental unit of the cross-linked polyethylene foam according to the present invention.

FIG. 3 shows a Lab Test Report indicating the thermal conductivity of the constructed foam according to the present invention.

FIG. 4 shows a plot for Random Incidence Sound Absorption Coefficient according to the present invention.

### DETAILED DESCRIPTION OF THE INVENTION

The present invention discloses the embodiment of the construction of the air filled foam of cross-linked polyethylene and a method to produce the same which enhances the thermal insulation and sound insulation of the product.

The construction of the foam consists of a plurality of air tunnels. These air tunnels are formulated in a manner which when joined together comprises of the final foam that possesses enhanced properties. The length of each air tunnel can be on an exemplary basis around 9 millimeters in length.

The embodiment of a singular air tunnel of the foam comprises of a plane sheet of a cross-linked low-density polyethylene and ribbed cross-linked polyethylene.

The cross-linked LDPE used for the same is XLPE and alternatively any other Polyethylene can also be used. On a preferential basis, cross-linked low-density polyethylene is used as the material for the formulation of the foam. The same possesses properties that are beneficial in nature for construction of foam. It is flexible in nature and has a wide turn radius. It can also be constructed and made by incorporating elbow joints. The thickness of the plane cross-linked polyethylene used in the foam is approximately 4 millimeters.

The 9 mm layer of the ribbed cross-linked polyethylene is situated beneath the cross linked LDPE. The layer of the ribbed cross-linked LDPE comprises of small chambers or tunnels that are approximately about 10 millimeters in thickness. They are evenly situated within the ribbed cross-linked LDPE layer. These chambers are filled with air. Hence, they can be referred to as air gaps. Accordingly a single layer of the air gaps or a double layer of the air gaps can be incorporated in the cross-linked LDPE depending upon requirement of thickness for the desired efficacy to be achieved.

The topmost layer of the foam is covered with an aluminium foil. The same is used for the purpose of the protecting the LDPE foam from atmosphere climate as well as to enhance the insulation of the foam.

The layers of the foam are laminated to each other for better holding capacity.

The thermal conductivity of the cross linked polyethylene foam, is substantially less at an approximation of around a range of 0.026±0.05 W/m·K which is comparatively less than the conventional foams and materials used for purposes of insulation.

The process to produce the same is mentioned herein.

For this process, a single extruder, a hot air circulating oven and a lamination machine are used.

Materials like LDPE and EVA (ethylene vinyl acetate) plastic resins are used.

Blowing agent, DCP and other additives such as FR chemicals, color or pigment, & anti microbial are used in form of master batch. The Blowing agent & DCP master batch and additive master batch are mixed at a low RPM mixer for an optimum time till the purpose of uniform distribution is achieved. The mixed material is then transferred from the mixer into a hopper of single extruder machine for sheet processing. In the single extruder machine a constant temperature of 115-130 degree Celsius is maintained whereas the constant backpressure that is maintained is 30-40 kg/cm². The material melts in the in the single extruder machine. This melted material is then passed through a specially designed T-shaped mold with specified constant gap of two-roll machine. The use of this T-shaped mold ensures that air gaps are achieved while manufacturing of the foam. After cooling of plastics sheets, they are bound-up in a roll for further process. The plastic sheet is then made to pass through the hot air circulating oven for cross-linking and blowing simultaneously at a range of 140 to 230 degree Celsius. Then this foamed sheet of plastic is laminated with Aluminum foil under heat and pressure on a lamination machine to produce the final foam product.

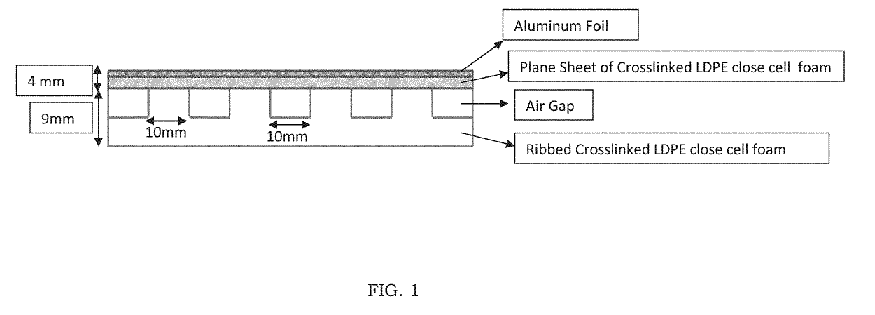

FIG. 1 describes a preferred embodiment of a fundamental unit or Tunnel of a cross-linked polyethylene foam, which comprises a sheet of Cross-linked LDPE (1) (Low Density Polyethylene) preferably 4 mm plane XLPE close cell foam sheet and Ribbed cross-linked LDPE close cell foam sheet (2). The length of each cell is say 10 mm. Within the layer of ribbed cross-linked LDPE (2), one layer of small air gap chambers (4) each of which is say 10 mm thick are situated. They are evenly spaced in the ribbed cross-linked LDPE layer (2). These chambers are filled with air (5). The top of the foam is covered with an aluminum foil (3).

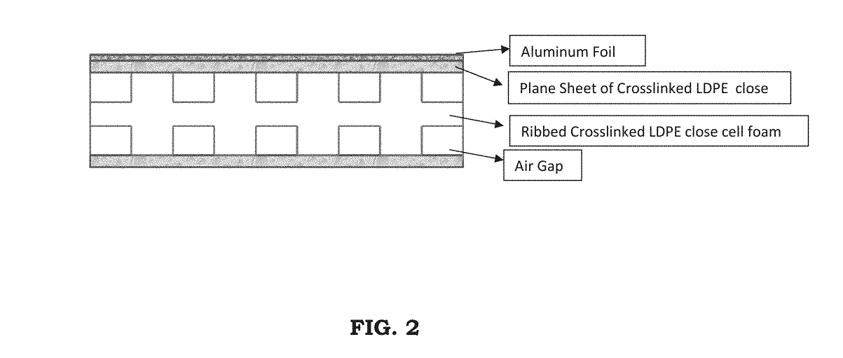

FIG. 2 describes another embodiment of a fundamental unit of cross-linked polyethylene foam of the present invention, which comprises two layers of cross-linked LDPE closed cell foam with a ribbed cross-linked LDPE sandwiched between them. Within the layer of ribbed cross-linked LDPE (2), two layers of small air tunnel chambers (4) are situated, which are filled with air (5). These chambers (4) are evenly spaced. The top of the foam is covered with an aluminum foil (3).

The thermal conductivity of the cross-linked polyethylene foam according to FIG. 2 is substantially less between 0.026±0.05 W/m°K and applies around 20% lesser use of polymer in the final product. The value of thermal conductivity shown within brackets and this percentage of polymer are purely exemplary and the present invention is not limited to it.

The final product according to the present invention has better flexibility, better sound and thermal insulation, lower cost and lesser smoke generation properties when exposed to fire.

The present invention has been described with reference to some drawings and preferred embodiments, purely for the sake of understanding and not by way of any limitation and the present invention includes all legitimate developments within the slope of what has been described herein before.

In addition to above, the cross-linked polyethylene foam also possesses acoustic insulation properties. The cross-linked polyethylene foam when used for sound insulation properties shows enhanced insulation properties than the other existing materials in the market.

Sample Test Results:

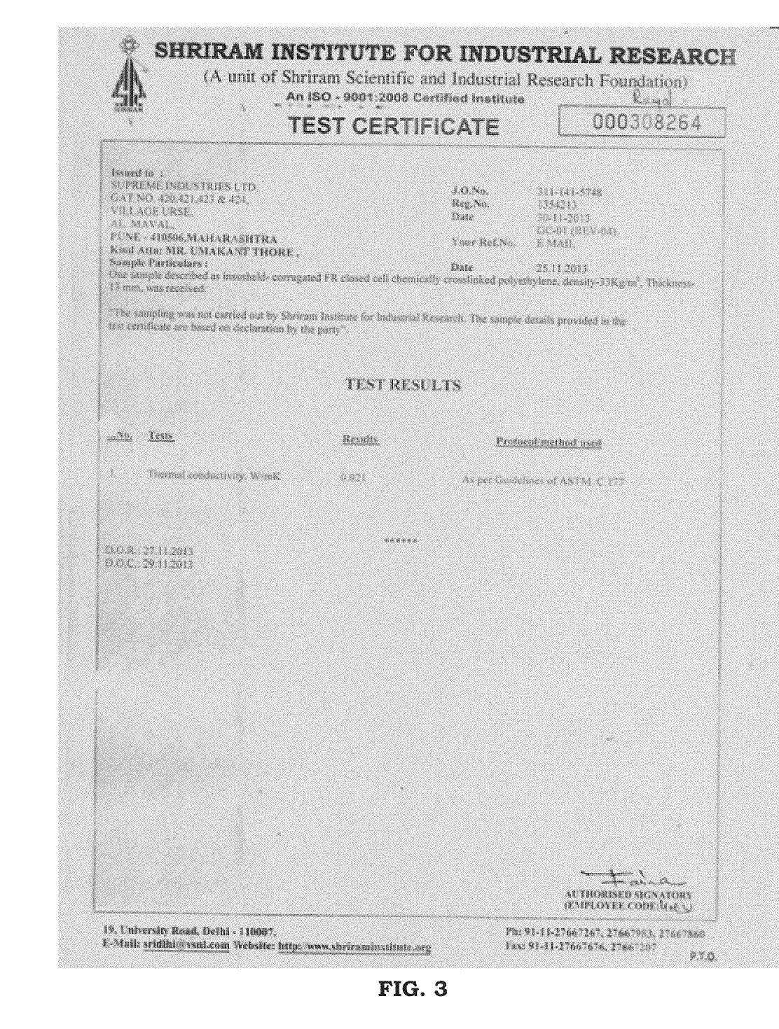

A sample construction of the foam that comprises of laminating a 9 mm corrugated sheet with 4 mm XLPE which when was tested for thermal conductivity. The results of the same according to the Lab Test Reports shown in FIG. 3, indicates the thermal conductivity of the constructed foam to be 0.026 W/m·K at an average range of ±0.05 W/m·K.

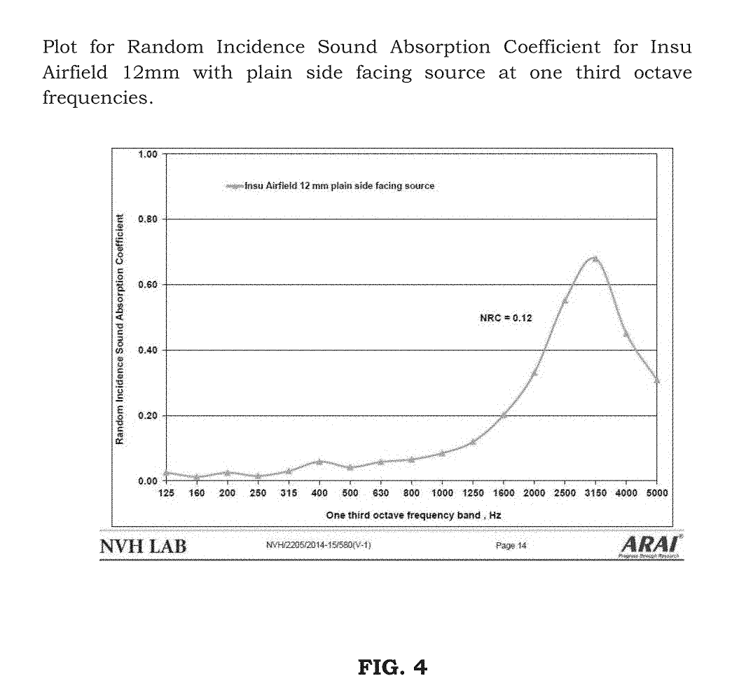

Although cross-linked low density close cell foam are not typically used as sound absorber, FIG. 4 shows the graph between sound absorption coefficient and frequency band in Hz emphasized of both air flow resistivity and random incidence sound absorption coefficient improving in middle frequency range and avoid too much absorption loses in higher frequency range. The figure shows a plot for Random Incidence Sound Absorption Coefficient for Insulated Airfield 12 mm with plain side facing source at one-third octave frequencies.

Hence, disclosed here is a cross-linked polyethylene close foam which has higher thermal insulation properties which is incorporated by adding air tunnels or air gaps and a method to produce the same. The same possesses sound insulation properties as well. The material is also available in large slab formats (sheet, rolls etc) and easily cut to shape with various cutting tools e.g. a knife.

1) A multilayered air filled close cell foam having increased thermal insulating properties with same density comprising of:
a ribbed foam layer of low-density polyethylene;
a plain foam layer of low-density polyethylene;
air gaps that are incorporated through ribbed molds, wherein the air gaps possess a pattern that provides an efficacy of thermal conductivity of 0.026±0.05 W°m/K.

2) The multilayered air filled close cell foam of claim 1, wherein the ribbed foam layer comprises cross-linked low-density polyethylene and consists of a plurality of said air gaps in an alternate manner with the polyethylene foam for increased thermal insulation.

3) The multilayered air filled close cell foam of claim 1, wherein said plain foam layer of low-density polyethylene is placed above the layer of ribbed polyethylene foam.

4) The multilayered air filled close cell foam of claim 2, comprising a ribbed mold incorporating the plurality of said air gaps in the ribbed cross-linked low-density polyethylene foam layer.

5) The multilayered air filled close cell foam of claim 1, wherein said air gaps reduce the amount of low-density polyethylene polymer used by 20%.

6) (canceled)

7) The multilayered air filled close cell foam of claim 1, further exhibiting acoustic insulation.

8) (canceled)

9) The multilayered air filled close cell foam of claim 1, further comprising a second plain foam layer of low-density polyethylene.

10) The multilayered air filled close cell foam of claim 9, wherein said ribbed foam layer of low-density polyethylene is placed between said plain foam layer of low-density polyethylene and said second plain foam layer of low-density polyethylene.

11) The multilayered air filled close cell foam of claim 10, wherein the ribbed foam layer comprises a first plurality of said air gaps placed near said plain foam layer of low-density polyethylene in an alternate manner with the polyethylene foam and a second plurality of said air gaps placed near said second plain foam layer of low-density polyethylene in an alternate manner with the polyethylene foam.

12) The multilayered air filled close cell foam of claim 1, wherein the ribbed foam layer of low-density polyethylene measures 9 mm.

13) The multilayered air filled close cell foam of claim 1, wherein the plain foam layer of low-density polyethylene measures 4 mm.

14) The multilayered air filled close cell foam of claim 1, wherein the air gaps measures 10 mm.

15) The multilayered air filled close cell foam of claim 1, wherein the space between air gaps measures 10 mm.
